(19) United States
(12) Patent Application Publication
(10) Pub. No.: US 2009/0277409 A1
(43) Pub. Date: Nov. 12, 2009

(54) COMBINED LUBRICANT AND FUEL PACKAGE FOR USE IN AN INTERNAL COMBUSTION ENGINE

(76) Inventors: Keith Selby, Chester Cheshire (GB); Trevor Stephenson, Chester Cheshire (GB); Mark Philip Wakem, Chester Cheshire (GB)

Correspondence Address: SHELL OIL COMPANY, P O BOX 2463, HOUSTON, TX, 772522463, US

(21) Appl. No.: 12/373,490

(22) PCT Filed: Jul. 12, 2007
(86) PCT No.: PCT/EP07/57162

§ 371 Date: Jan. 12, 2009

(30) Foreign Application Priority Data
Jul. 12, 2006 (EP) 06117078.3
Jul. 12, 2006 (EP) 06117080.9

(51) Int. Cl. F02B 43/00

(52) U.S. Cl. 123/1 A

(57) ABSTRACT

The present invention relates to a combined lubricant and fuel composition package for operating a diesel engine, wherein the lubricant comprises a base oil comprising (i) a continuous series of iso-paraffins having n, n+1, n+2, n+3 and n+4 carbon atoms, and/or (ii) a continuous series of iso-paraffins having n, n+2 and n+4 carbon atoms and not containing n+1, and n+3; wherein n is between 15 and 40; and wherein the fuel composition comprises a paraffinic gas oil component having a paraffin content of greater than 80 wt % paraffins and a saturates content of greater than 98 wt %, and to its use in the reduction of nitrogen oxide in engine operation.

### FIELD OF INVENTION

The present invention relates to lubricant and fuel for a combined use in a combustion engine. More specifically, the invention relates to a lubricant and fuel package for use in an internal combustion compression ignition engine.

### BACKGROUND OF THE INVENTION

In recent decades, use of internal combustion engines, in particular compression ignition engines for transportation and other means of energy generation has become more and more widespread. Compression ignition engines, which will be referred to further as “Diesel engines” after Rudolf Diesel, who invented the first compression ignition engine in 1892, feature among the main type of engines employed for passenger cars in Europe, and globally for heavy duty applications, as well as for stationary power generation as a result of their high efficiency.

A diesel engine is an internal combustion engine; more specifically, it is a compression ignition engine, in which the fuel/air mixture is ignited by being compressed until it ignites due to the temperature increase due to compression, rather than by a separate source of ignition, such as a spark plug, as is the case of gasoline engines.

The growing spread of Diesel engines has resulted in increased regulatory pressure with respect to engine emissions; more specifically with respect to exhaust gases and particulate matter in the exhaust gas stream.

A variety of strategies for controlling and reducing in particular particulate matter emissions from Diesel engines have been reported in recent years. These include the use of fuel additives, specific mineral oil derived fuels of low sulphur contents, and/or synthetic fuels, as for instance described in US-A-20050154240. This document discloses the use of highly iso-paraffinic based gas oils derived from a Fischer-Tropsch process for reducing particulate emission from compression ignition engines. Other approaches include the formulation of low sulphur lubricant compositions comprising active compounds such as acylated nitrogen-containing compounds as disclosed in WO-A-02/24842. Yet other approaches to reduce particulate exhaust emissions have focused on engine management, more specifically injection and combustion processes, as disclosed for instance in U.S. Pat. No. 6,651,614. The trend to improved engine management has generally led to higher combustion temperatures, which result in increased formation of nitrogen oxides. Nitrogen oxides (NOx) are demonstrated to be hazardous to both plant and animal health, and are difficult and slow to convert by fixed-bed catalyst systems, as for instance those described in U.S. Pat. No. 6,696,389, and/or may require further cumbersome and complex treatment, as for instance disclosed in EP-A-1010870.

Hence, there is a need for a further reduction of nitrogen oxides in diesel engine exhaust gases.

It has now surprisingly been found by applicants that by using a combination of a specific lubricant and fuel, the amount of nitrogen oxides in the exhaust gases can be significantly reduced.

### SUMMARY OF THE INVENTION

Accordingly, the present invention relates to a combined lubricant and fuel composition package for use in a diesel engine, wherein the lubricant comprises a base oil comprising (i) a series of iso-paraffins having n, n+1, n+2, n+3 and n+4 carbon atoms, and/or (ii) a series of iso-paraffins having n, n+2 and n+4 carbon atoms, however not n+1 or n+3, and wherein n is between 15 and 40, and wherein the fuel composition comprises from 5 to 100% wt. of a paraffinic gas oil component having a paraffin content of greater than 80 wt % paraffins and a saturates content of greater than 98 wt %.

### DETAILED DESCRIPTION OF THE FIGURE

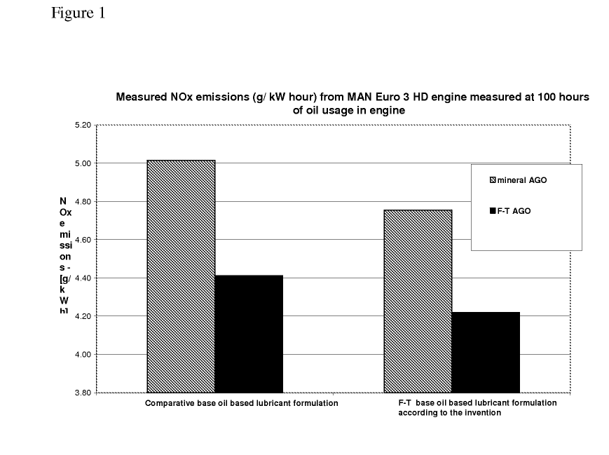

FIG. 1 shows a comparison between four heavy duty diesel test cycles.

### DETAILED DESCRIPTION OF THE INVENTION

The present invention relates to the synergetic combination of a lubricant used to lubricate a compression ignition internal combustion engine, i.e. a Diesel Engine, a reciprocating engine, rotary engine (also referred to as Wankel engine) and similar designed engine in which combustion is intermittent, and to a fuel that is used to run this engine simultaneously.

Applicants have found that the use of a lubricant comprising a Fischer-Tropsch derived base oil and/or of a poly alpha olefin (PAO) derived base oil in combination with a fuel comprising a paraffinic gas oil component as set out above leads to a significant and unexpected synergistic reduction of nitrogen oxide emission of a Diesel engine.

The diesel engine for which the package according to the invention is to be employed is lubricated, i.e. the lubricant forms a film between surfaces of parts moving against each other so as to minimize direct contact between them. This lubricating film decreases friction, wearing, and production of excessive heat between the moving parts. Also as a moving fluid, the lubricant transposes heat from surfaces of lubricated parts due to friction from parts moving against each other or the oil film. Typically, a Diesel engine has a crankcase, cylinder head, and cylinders. The lubricant is typically present in the crankcase, where crankshaft, bearings, and bottoms of rods connecting pistons to the crankshaft are coated in the lubricant. The rapid motion of these parts causes the lubricant to splash and lubricate the contacting surfaces between the piston rings and interior surfaces of the cylinders. This lubricant film also serves as a seal between the piston rings and cylinder walls to separate the combustion volume in the cylinders from the space in the crankcase.

Without wishing to be bound to any particular theory, it is believed that the presence of the residual lubricant film, in synergy with the specific highly paraffinic fuel reduces the temperature of the piston and interior surfaces of the cylinder, thereby reducing the formation of nitrogen oxides.

The fuel composition of the combination according to the invention comprises is suitable for compression ignition engines. Accordingly, it comprises one or more fuel components that by boiling range and other structure are suitable to act as fuel for compression ignition engines. Generally, such engines employ piston crown lubrication, which is preferred, since hereby the lubricant contributes to the engine cooling. In such engines, the piston is usually formed as a cast article having a crown portion and a hollow cylindrical side wall portion, wherein the crown portion is formed with a transverse hollow space, wherein the hollow space is circulated by lubricant for the purpose of cooling the crown portion. Lubricant is supplied to the hollow space by splashing.

The fuel composition preferably has a cetane number of at least 40, a sulphur content of less than 100 ppm and a flash point of at least 68° C., and furthermore contains less than 10% by mass aromatics. The fuel composition according to invention may comprise one or more fuel components, of which preferably at least one is a paraffinic gas oil component. The fuel may advantageously comprise a mixture of two or more Fischer-Tropsch derived gas oil and/or kerosene fuels, optionally in admixture with non-Fischer-Tropsch derived gas oils and/or kerosenes. The fuel composition may further comprise additives usually employed in fuels.

With a paraffinic gas oil component in the context of the present invention is meant a composition comprising more than 80 wt % paraffins, more preferably more than 90 wt % paraffins and even more preferably more than 95 wt % paraffins. The iso to normal ratio of the paraffins as present in the paraffin fuel is preferably greater than 0.3, more preferably greater than 1, even more preferably greater than 3. The paraffin fuel may comprise of substantially only iso-paraffins.

The paraffinic gas oil component preferably comprises a series of iso-paraffins having n, n+1, n+2, n+3 and n+4 carbon atoms, and wherein n is between 8 and 25.

Such paraffinic gas oils are preferably obtained from a Fischer-Tropsch synthesis process, in particular those boiling in the gas oil and/or kerosene range. Preferably, the paraffinic gas oil component is a Fischer-Tropsch derived gas oil, or a blend thereof.

The fuel composition according to the invention comprises a mixture of normal paraffins and iso-paraffins, the normal paraffins present in an amount of less than 99% by weight of the fuel composition; and aromatic hydrocarbons present in an amount of less than 10% by weight of the gas oil fuel.

Preferably, the paraffinic gas oil component has an iso-paraffin to n-paraffin mass ratio that generally increases as paraffin carbon number increases from C8 to C18.

The components of the gas oil component preferably have boiling points within the typical diesel fuel (“gas oil”) range, i.e., from about 150 to 400° C. or from 170 to 370° C. It will suitably have a 90% w/w distillation temperature of from 300 to 370° C.

The gas oil component employed in the fuel composition in accordance with the present invention preferably further comprises at least 80% w/w, more preferably at least 90% w/w, most preferably at least 95% w/w, of paraffinic components, preferably iso- and linear paraffins. The weight ratio of iso-paraffins to normal paraffins will suitably be greater than 0.3 and may be up to 12; suitably it is from 2 to 6.

By “Fischer-Tropsch derived” is meant that a fuel component or a base oil is, or derives from, a synthesis product of a Fischer-Tropsch condensation process. The term “non-Fischer-Tropsch derived” may be interpreted accordingly. A Fischer-Tropsch derived fuel may also be referred to as a GTL (Gas-To-Liquids) fuel. The Fischer-Tropsch reaction converts carbon monoxide and hydrogen into longer chain, usually paraffinic, hydrocarbons: n(CO+2H₂)═(—CH₂—)ₙ+nH₂O+heat, in the presence of an appropriate catalyst and typically at elevated temperatures (e.g., 125 to 300° C., preferably 175 to 250° C.) and/or pressures (e.g., 5 to 100 bar, preferably 12 to 50 bar). Hydrogen to carbon monoxide ratios other than 2:1 may be employed if desired. The carbon monoxide and hydrogen may themselves be derived from organic or inorganic, natural or synthetic sources, typically either from natural gas or from organically derived methane.

The actual value for this ratio will be determined, in part, by the hydroconversion process used to prepare the gas oil or fuel component derived from the Fischer-Tropsch synthesis product. Preferably, the Fischer-Tropsch derived gas oil the fuel comprises at least 50% w/w of iso-paraffins. Some cyclic paraffins may also be present.

Preferably, the Fischer-Tropsch derived gas oil has an average of more than 1 alkyl branch per paraffinic molecule. Fischer-Tropsch derived gas oils according to the invention as described herein-above may be obtained directly from the Fischer-Tropsch reaction, or indirectly for instance by fractionation of Fischer-Tropsch synthesis products or from hydrotreated Fischer-Tropsch synthesis products. Hydrotreatment can involve hydrocracking to adjust the boiling range (see, e.g., GB-B-2077289 and EP-A-0147873) and/or hydroisomerisation which can improve cold flow properties by increasing the proportion of branched paraffins. EP-A-0583836 describes a two step hydrotreatment process in which a Fischer-Tropsch synthesis product is firstly subjected to hydroconversion under conditions such that it undergoes substantially no isomerisation or hydrocracking (this hydrogenates the olefinic and oxygen-containing components), and then at least part of the resultant product is hydroconverted under conditions such that hydrocracking and isomerisation occur to yield a substantially paraffinic hydrocarbon fuel. The desired gas oil fraction(s) may subsequently be isolated for instance by distillation.

Other post-synthesis treatments, such as polymerisation, alkylation, distillation, cracking-decarboxylation, dewaxing, isomerisation and hydroreforming, may be employed to modify the properties of Fischer-Tropsch condensation products, as described for instance in U.S. Pat. No. 4,125,566 and U.S. Pat. No. 4,478,955. Typical catalysts for the Fischer-Tropsch synthesis of paraffinic hydrocarbons comprise, as the catalytically active component, a metal from Group VIII of the periodic table, in particular ruthenium, iron, cobalt or nickel. Suitable such catalysts are described for instance in EP-A-0583836 (pages 3 and 4).

An example of a Fischer-Tropsch based process is the SMDS (Shell Middle Distillate Synthesis) described in “The Shell Middle Distillate Synthesis Process”, van der Burgt et al (supra). This process (also sometimes referred to as the Shell “Gas-To-Liquids” or “GTL” technology) produces middle distillate range products by conversion of a natural gas (primarily methane) derived synthesis gas into a heavy long chain hydrocarbon (paraffin) wax which can then be hydroconverted and fractionated to produce liquid transport fuels such as the gas oils useable in diesel fuel compositions. A version of the SMDS process, utilising a fixed bed reactor for the catalytic conversion step, is currently in use in Bintulu, Malaysia and its gas oil products have been blended with petroleum derived gas oils in commercially available automotive fuels.

Gas oils prepared by the SMDS process are commercially available for instance from Shell companies. Further examples of Fischer-Tropsch derived gas oils are described in EP-A-0583836, EP-A-1101813, WO-A-97/14768, WO-A-97/14769, WO-A-00/20534, WO-A-00/20535, WO-A-00/11116, WO-A-00/11117, WO-A-01/83406, WO-A-01/83641, WO-A-01/83647, WO-A-01/83648 and U.S. Pat. No. 6,204,426.

By virtue of the Fischer-Tropsch process, a Fischer-Tropsch derived fuel has essentially no, or detection limit levels of, sulphur and nitrogen. Compounds containing these heteroatoms tend to act as poisons for Fischer-Tropsch catalysts and are therefore removed from the synthesis gas feed. This can yield additional benefits, in terms of effect on catalyst performance, in fuel compositions in accordance with the present invention.

Further, the Fischer-Tropsch process as usually operated produces no or virtually no aromatic components. The aromatics content of a Fischer-Tropsch derived fuel, suitably determined by ASTM D4629, will typically be below 1% w/w, preferably below 0.5% w/w and more preferably below 0.1% w/w.

Generally speaking, Fischer-Tropsch derived fuels have relatively low levels of polar components, in particular polar surfactants, for instance compared to petroleum derived fuels. It is believed that this can contribute to improved antifoaming and dehazing performance. Such polar components may include for example oxygenates, and sulphur and nitrogen containing compounds. A low level of sulphur in a Fischer-Tropsch derived fuel is generally indicative of low levels of both oxygenates and nitrogen-containing compounds, since all are removed by the same treatment processes.

As set out above, the fuel according to the invention may include a mixture of two or more Fischer-Tropsch derived gas oil and kerosene fuels. The components of a Fischer-Tropsch derived gas oil (or the majority, for instance 95% w/w or greater, thereof) preferably have boiling points within the typical diesel fuel (“gas oil”) range, i.e., from about 150 to 400° C. or from 170 to 370° C. The gas oil component will suitably have a 90% w/w distillation temperature of from 300 to 370° C.

Preferably, the paraffinic gas oil has an iso-paraffin to n-paraffin mass ratio that generally increases as paraffin carbon number increases from C8 to C18, and wherein the fuel comprises less than 0.05% m/m sulphur and less than 10% by mass aromatics. Preferably, the gas oil has an average of more than 1 alkyl branch per paraffinic molecule. Preferably, the fuel comprises at least 50 mass % iso-paraffins.

The paraffinic gas oil will typically have a density from 0.76 to 0.79 g/cm³ at 15° C.; a cetane number (ASTM D613) of at least 65, preferably greater than 70, suitably from 74 to 85; a kinematic viscosity (ASTM D445) from 2 to 4.5, preferably from 2.5 to 4.0, more preferably from 2.9 to 3.7, centistokes at 40° C.; and a sulphur content (ASTM D2622) of 5 ppmw or less, preferably of 2 ppmw or less.

Preferably, the paraffinic gas oil is a product prepared by a Fischer-Tropsch methane condensation reaction using a hydrogen/carbon monoxide ratio of less than 2.5, preferably less than 1.75, more preferably from 0.4 to 1.5, and ideally using a cobalt containing catalyst. It may be obtained from a hydrocracked Fischer-Tropsch synthesis product (for instance as described in GB-B-2077289 and/or EP-A-0147873), or more preferably a product from a two-stage hydroconversion process such as that described in EP-A-0583836 (see above). In the latter case, preferred features of the hydroconversion process may be as disclosed at pages 4 to 6, and in the examples, of EP-A-0583836. A fuel composition according to the invention may include a mixture of two or more Fischer-Tropsch derived gas oils. The Fischer-Tropsch derived fuel, and any other fuel component(s) present in the composition, will suitably all be in liquid form under ambient conditions.

The present invention may be applicable where the fuel composition is suitable for, and/or intended for, use in any system which can be powered by or otherwise consume a fuel, in particular a diesel fuel, composition. In particular it may be suitable, and/or intended, for use in an internal or external (preferably internal) combustion engine, more particularly for use as an automotive fuel and most particularly for use in an internal combustion engine of the compression ignition (diesel) type.

The fuel composition will preferably be, overall, a low or ultra low sulphur fuel composition, or a sulphur free fuel composition, for instance containing at most 500 ppmw, preferably no more than 350 ppmw, most preferably no more than 100 or 50 ppmw, or even 10 ppmw or less, of sulphur.

Where the fuel composition is an automotive diesel fuel composition, it preferably falls within applicable current standard specification(s) such as for example EN 590:99. It suitably has a density from 0.82 to 0.845 g/cm³ at 15° C.; a final boiling point (ASTM D86) of 360° C. or less; a cetane number (ASTM D613) of 51 or greater; a kinematic viscosity (ASTM D445) from 2 to 4.5 centistokes at 40° C.; a sulphur content (ASTM D2622) of 350 ppmw or less; and/or a total aromatics content (IP 391(mod)) of less than 11.

The fuel composition according to the invention preferably contains less than 50% v/v of a non-Fischer-Tropsch derived diesel base fuel, more preferably less than 30% v/v, yet more preferably less than 25% v/v, less than 20% v/v, yet more preferably less than 15% v/v, again more preferably less than 10% v/v, yet more preferably less than 8% v/v, again yet more preferably less than 5% v/v, and most preferably less than 2% v/v of a non-Fischer-Tropsch derived fuel.

The fuel composition may also contain up to 30% v/v of a Fischer-Tropsch derived kerosene fuel. All concentrations, unless otherwise stated, are quoted as percentages of the overall fuel composition. The concentrations of the Fischer-Tropsch derived gas oil, will generally be chosen to ensure that the density, cetane number, calorific value and/or other relevant properties of the overall fuel composition are within the desired ranges, for instance within commercial or regulatory specifications.

The fuel composition employed in the lubricant-and-fuel combination according to the present invention may contain other components in addition to the non-Fischer-Tropsch derived fuel and the Fischer-Tropsch derived fuel components.

The base fuel may itself be additivated (additive-containing) or unadditivated (additive-free). If additivated, it will contain one or more additives selected for example from anti-static agents, pipeline drag reducers, flow improvers (e.g. ethylene/vinyl acetate copolymers or acrylate/maleic anhydride copolymers), lubricity additives, antioxidants and wax anti-settling agents.

Detergent-containing diesel fuel additives are known and commercially available. Such additives may be added to diesel fuels at levels intended to reduce, remove, or slow the build up of engine deposits. Examples of detergents suitable for use in fuel additives for the present purpose include polyolefin substituted succinimides or succinamides of polyamines, for instance polyisobutylene succinimides or polyisobutylene amine succinamides, aliphatic amines, Mannich bases or amines and polyolefin (e.g. polyisobutylene) maleic anhydrides. Succinimide dispersant additives are described for example in GB-A-960493, EP-A-0147240, EP-A-0482253, EP-A-0613938, EP-A-0557516 and WO-A-98/42808. Particularly preferred are polyolefin substituted succinimides such as polyisobutylene succinimides.

The additive may contain other components in addition to the detergent. Examples are lubricity enhancers; dehazers, e.g. alkoxylated phenol formaldehyde polymers; anti-foaming agents (e.g. polyether-modified polysiloxanes); ignition improvers (cetane improvers) (e.g. 2-ethylhexyl nitrate (EHN), cyclohexyl nitrate, di-tert-butyl peroxide and those disclosed in U.S. Pat. No. 4,208,190 at column 2, line 27 to column 3, line 21); anti-rust agents (e.g. a propane-1,2-diol semi-ester of tetrapropenyl succinic acid, or polyhydric alcohol esters of a succinic acid derivative, the succinic acid derivative having on at least one of its alpha-carbon atoms an unsubstituted or substituted aliphatic hydrocarbon group containing from 20 to 500 carbon atoms, e.g. the pentaerythritol diester of polyisobutylene-substituted succinic acid); corrosion inhibitors; reodorants; anti-wear additives; anti-oxidants (e.g. phenolics such as 2,6-di-tert-butylphenol, or phenylenediamines such as N,N′-di-sec-butyl-p-phenylenediamine); metal deactivators; and combustion improvers. It is particularly preferred that the additive include a lubricity enhancer, especially when the fuel composition has a low (e.g. 500 ppmw or less) sulphur content. In the additivated fuel composition, the lubricity enhancer is conveniently present at a concentration of less than 1000 ppmw, preferably between 50 and 1000 ppmw, more preferably between 100 and 1000 ppmw. Suitable commercially available lubricity enhancers include ester- and acid-based additives. Other lubricity enhancers are described in the patent literature, in particular in connection with their use in low sulphur content diesel fuels, for example in:

the paper by Danping Wei and H. A. Spikes, “The Lubricity of Diesel Fuels”, Wear, III (1986) 217-235;

WO-A-95/33805—cold flow improvers to enhance lubricity of low sulphur fuels;

WO-A-94/17160—certain esters of a carboxylic acid and an alcohol wherein the acid has from 2 to 50 carbon atoms and the alcohol has 1 or more carbon atoms, particularly glycerol monooleate and di-isodecyl adipate, as fuel additives for wear reduction in a diesel engine injection system;

U.S. Pat. No. 5,490,864—certain dithiophosphoric diester-dialcohols as anti-wear lubricity additives for low sulphur diesel fuels; and.

WO-A-98/01516—certain alkyl aromatic compounds having at least one carboxyl group attached to their aromatic nuclei, to confer anti-wear lubricity effects particularly in low sulphur diesel fuels.

It is also preferred that the additive contain an anti-foaming agent, more preferably in combination with an anti-rust agent and/or a corrosion inhibitor and/or a lubricity additive.

Unless otherwise stated, the (active matter) concentration of each such additional component in the additivated fuel composition is preferably up to 10000 ppmw, more preferably in the range from 0.1 to 1000 ppmw, advantageously from 0.1 to 300 ppmw, such as from 0.1 to 150 ppmw.

The (active matter) concentration of any dehazer in the fuel composition will preferably be in the range from 0.1 to 20 ppmw, more preferably from 1 to 15 ppmw, still more preferably from 1 to 10 ppmw, advantageously from 1 to 5 ppmw. The (active matter) concentration of any ignition improver present will preferably be 2600 ppmw or less, more preferably 2000 ppmw or less, conveniently from 300 to 1500 ppmw.

If desired, the additive components, as listed above, may be co-mixed, preferably together with suitable diluent(s), in an additive concentrate, and the additive concentrate may be dispersed into the fuel, in suitable quantity to result in a composition of the present invention.

In the case of a diesel fuel composition, for example, the additive will typically contain a detergent, optionally together with other components as described above, and a diesel fuel-compatible diluent, which may be a carrier oil (e.g. a mineral oil), a polyether, which may be capped or uncapped, a non-polar solvent such as toluene, xylene, white spirits and those sold by Shell companies under the trade mark “SHELLSOL”, and/or a polar solvent such as an ester and, in particular, an alcohol, e.g. hexanol, 2-ethylhexanol, decanol, isotridecanol and alcohol mixtures such as those sold by Shell companies under the trade mark “LINEVOL”, especially LINEVOL 79 alcohol which is a mixture of C₇₋₉ primary alcohols, or a C₁₂₋₁₄ alcohol mixture which is commercially available. The total content of the additives may be suitably between 0 and 10000 ppmw and preferably below 5000 ppmw.

The lubricant of the combined lubricant and fuel package comprises at least one base oil having a paraffin content of greater than 80 wt % paraffins and a saturates content of greater than 98 wt % and comprising a continuous series of iso-paraffins having n, n+1, n+2, n+3 and n+4 carbon atoms, or a series of iso-paraffins having n, n+2 and n+4 carbon atoms and wherein n is between 15 and 35, and wherein n is between 15 and 35.

The base oil preferably is a Fischer-Tropsch derived base oil, having a paraffin content of greater than 80 wt % paraffins, a saturates content of greater than 98 wt % and comprises a continuous series of iso-paraffins having n, n+1, n+2, n+3 and n+4 carbon atoms, wherein n is between 15 and 40. In the case of the Fischer-Tropsch derived base oil, the base oil contains a continuous series of the series of iso-paraffins having n, n+1, n+2, n+3 and n+4 carbon atoms. The content and the presence of the a continuous series of the series of iso-paraffins having n, n+1, n+2, n+3 and n+4 carbon atoms in the base oil or base stock (i) may be measured by Field desorption/Field Ionisation (FD/FI) technique. In this technique the oil sample is first separated into a polar (aromatic) phase and a non-polar (saturates) phase by making use of a high performance liquid chromatography (HPLC) method IP368/01, wherein as mobile phase pentane is used instead of hexane as the method states. The saturates and aromatic fractions are then analyzed using a Finnigan MAT90 mass spectrometer equipped with a Field desorption/Field Ionisation (FD/FI) interface, wherein FI (a “soft” ionisation technique) is used for the determination of hydrocarbon types in terms of carbon number and hydrogen deficiency. The type classification of compounds in mass spectrometry is determined by the characteristic ions formed and is normally classified by “z number”. This is given by the general formula for all hydrocarbon species: CₙH_{2n+z}. Because the saturates phase is analysed separately from the aromatic phase it is possible to determine the content of the different iso-paraffins having the same stoichiometry or n-number. The results of the mass spectrometer are processed using commercial software (poly 32; available from Sierra Analytics LLC, 3453 Dragoo Park Drive, Modesto, Calif. GA95350 USA) to determine the relative proportions of each hydrocarbon type.

The base oil containing a continuous iso-paraffinic series as described above is obtained by hydroisomerisation of a paraffinic wax, preferably followed by some type of dewaxing, such as solvent or catalytic dewaxing. The paraffinic wax is a Fischer-Tropsch derived wax.

The base oils as derived from a Fischer-Tropsch wax as here described will be referred to in this description as Fischer-Tropsch derived base oils. Examples of Fischer-Tropsch processes which for example can be used to prepare the above-described Fischer-Tropsch derived base oil are the so-called commercial Slurry Phase Distillate technology of Sasol, the Shell Middle Distillate Synthesis Process and the “AGC-21” Exxon Mobil process. These and other processes are for example described in more detail in EP-A-776959, EP-A-668342, U.S. Pat. No. 4,943,672, U.S. Pat. No. 5,059,299, WO-A-9934917 and WO-A-9920720. Typically these Fischer-Tropsch synthesis products will comprise hydrocarbons having 1 to 100 and even more than 100 carbon atoms. This hydrocarbon product will comprise normal paraffins, iso-paraffins, oxygenated products and unsaturated products. If base oils are one of the desired iso-paraffinic products it may be advantageous to use a relatively heavy Fischer-Tropsch derived feed. The relatively heavy Fischer-Tropsch derived feed has at least 30 wt %, preferably at least 50 wt %, and more preferably at least 55 wt % of compounds having at least 30 carbon atoms. Furthermore the weight ratio of compounds having at least 60 or more carbon atoms and compounds having at least 30 carbon atoms of the Fischer-Tropsch derived feed is preferably at least 0.2, more preferably at least 0.4 and most preferably at least 0.55. Preferably the Fischer-Tropsch derived feed comprises a C₂₀⁺ fraction having an ASF-alpha value (Anderson-Schulz-Flory chain growth factor) of at least 0.925, preferably at least 0.935, more preferably at least 0.945, even more preferably at least 0.955. Such a Fischer-Tropsch derived feed can be obtained by any process, which yields a relatively heavy Fischer-Tropsch product as described above. Not all Fischer-Tropsch processes yield such a heavy product. An example of a suitable Fischer-Tropsch process is described in WO-A-9934917. The Fischer-Tropsch derived base oil will contain no or very little sulphur and nitrogen containing compounds. This is typical for a product derived from a Fischer-Tropsch reaction, which uses synthesis gas containing almost no impurities. Sulphur and nitrogen levels will generally be below the detection limits, which are currently 5 mg/kg for sulphur and 1 mg/kg for nitrogen respectively.

The process will generally comprise a Fischer-Tropsch synthesis, a hydroisomerisation step and an optional pour point reducing step, wherein said hydroisomerisation step and optional pour point reducing step are performed as: (a) hydrocracking/hydroisomerisating a Fischer-Tropsch product, (b) separating the product of step (a) into at least one or more distillate fuel fractions and a base oil or base oil intermediate fraction.

If the viscosity and pour point of the base oil as obtained in step (b) is as desired no further processing is necessary and the oil can be used as the base oil according the invention. If required, the pour point of the base oil intermediate fraction is suitably further reduced in a step (c) by means of solvent or preferably catalytic dewaxing of the oil obtained in step (b) to obtain oil having the preferred low pour point. The desired viscosity of the base oil may be obtained by isolating by means of distillation from the intermediate base oil fraction or from the dewaxed oil the a suitable boiling range product corresponding with the desired viscosity. Distillation may be suitably a vacuum distillation step.

The hydroconversion/hydroisomerisation reaction of step (a) is preferably performed in the presence of hydrogen and a catalyst, which catalyst can be chosen from those known to one skilled in the art as being suitable for this reaction of which some will be described in more detail below. The catalyst may in principle be any catalyst known in the art to be suitable for isomerising paraffinic molecules. In general, suitable hydroconversion/hydroisomerisation catalysts are those comprising a hydrogenation component supported on a refractory oxide carrier, such as amorphous silica-alumina (ASA), alumina, fluorided alumina, molecular sieves (zeolites) or mixtures of two or more of these. One type of preferred catalysts to be applied in the hydroconversion/hydroisomerisation step in accordance with the present invention are hydroconversion/hydroisomerisation catalysts comprising platinum and/or palladium as the hydrogenation component. A very much preferred hydroconversion/hydroisomerisation catalyst comprises platinum and palladium supported on an amorphous silica-alumina (ASA) carrier. The platinum and/or palladium is suitably present in an amount of from 0.1 to 5.0% by weight, more suitably from 0.2 to 2.0% by weight, calculated as element and based on total weight of carrier. If both present, the weight ratio of platinum to palladium may vary within wide limits, but suitably is in the range of from 0.05 to 10, more suitably 0.1 to 5. Examples of suitable noble metal on ASA catalysts are, for instance, disclosed in WO-A-9410264 and EP-A-0582347. Other suitable noble metal-based catalysts, such as platinum on a fluorided alumina carrier, are disclosed in e.g. U.S. Pat. No. 5,059,299 and WO-A-9220759. A second type of suitable hydroconversion/hydroisomerisation catalysts are those comprising at least one Group VIB metal, preferably tungsten and/or molybdenum, and at least one non-noble Group VIII metal, preferably nickel and/or cobalt, as the hydrogenation component. Both metals may be present as oxides, sulphides or a combination thereof. The Group VIB metal is suitably present in an amount of from 1 to 35% by weight, more suitably from 5 to 30% by weight, calculated as element and based on total weight of the carrier. The non-noble Group VIII metal is suitably present in an amount of from 1 to 25 wt %, preferably 2 to 15 wt %, calculated as element and based on total weight of carrier. A hydroconversion catalyst of this type, which has been found particularly suitable, is a catalyst comprising nickel and tungsten supported on fluorided alumina.

The above non-noble metal-based catalysts are preferably used in their sulphided form. In order to maintain the sulphided form of the catalyst during use some sulphur needs to be present in the feed. Preferably at least 10 mg/kg and more preferably between 50 and 150 mg/kg of sulphur is present in the feed.

A preferred catalyst, which can be used in a non-sulphided form, comprises a non-noble Group VIII metal, e.g., iron, nickel, in conjunction with a Group IB metal, e.g., copper, supported on an acidic support. Copper is preferably present to suppress hydrogenolysis of paraffins to methane. The catalyst has a pore volume preferably in the range of 0.35 to 1.10 ml/g as determined by water absorption, a surface area of preferably between 200-500 m²/g as determined by BET nitrogen adsorption, and a bulk density of between 0.4-1.0 g/ml. The catalyst support is preferably made of an amorphous silica-alumina wherein the alumina may be present within wide range of between 5 and 96 wt %, preferably between 20 and 85 wt %. The silica content as SiO₂ is preferably between 15 and 80 wt %. Also, the support may contain small amounts, e.g., 20-30 wt %, of a binder, e.g., alumina, silica, Group IVA metal oxides, and various types of clays, magnesia, etc., preferably alumina or silica. The preparation of amorphous silica-alumina microspheres has been described in Ryland, Lloyd B., Tamele, M. W., and Wilson, J. N., Cracking Catalysts, Catalysis: volume VII, Ed. Paul H. Emmett, Reinhold Publishing Corporation, New York, 1960, pp. 5-9.

The catalyst is prepared by co-impregnating the metals from solutions onto the support, drying at 100-150° C., and calcining in air at 200-550° C. The Group VIII metal is present in amounts of about 15 wt % or less, preferably 1-12 wt %, while the Group IB metal is usually present in lesser amounts, e.g., 1:2 to about 1:20 weight ratio respecting the Group VIII metal.

A typical catalyst is shown below:

| Ni, wt % | 2.5-3.5 | |
|---|---|---|
| Cu, wt % | 0.25-0.35 | |
| Al₂O₃—SiO₂ wt % | 65-75 | |
| Al₂O₃ (binder) wt % | 25-30 | |
| Surface Area | 290-325 | m²/g |
| Pore Volume (Hg) | 0.35-0.45 | ml/g |
| Bulk Density | 0.58-0.68 | g/ml |

Another class of suitable hydroconversion/hydroisomerisation catalysts are those based on molecular sieve type materials, suitably comprising at least one Group VIII metal component, preferably Pt and/or Pd, as the hydrogenation component. Suitable zeolitic and other aluminosilicate materials, then, include Zeolite beta, Zeolite Y, Ultra Stable Y, ZSM-5, ZSM-12, ZSM-22, ZSM-23, ZSM-48, MCM-68, ZSM-35, SSZ-32, ferrierite, mordenite and silica-aluminophosphates, such as SAPO-11 and SAPO-31. Examples of suitable hydroisomerisation/hydroisomerisation catalysts are, for instance, described in WO-A-9201657. Combinations of these catalysts are also possible. Very suitable hydroconversion/hydroisomerisation processes are those involving a first step wherein a zeolite beta or ZSM-48 based catalyst is used and a second step wherein a ZSM-5, ZSM-12, ZSM-22, ZSM-23, ZSM-48, MCM-68, ZSM-35, SSZ-32, ferrierite, mordenite based catalyst is used. Of the latter group ZSM-23, ZSM-22 and ZSM-48 are preferred. Examples of such processes are described in U.S.A. 20040065581, which disclose a process comprising a first step catalyst comprising platinum and zeolite beta and a second step catalyst comprising platinum and ZSM-48. These processes are capable of yielding a base oil product which does not require a further dewaxing step.

Combinations wherein the Fischer-Tropsch product is first subjected to a first hydroisomerisation step using the amorphous catalyst comprising a silica-alumina carrier as described above followed by a second hydroisomerisation step using the catalyst comprising the molecular sieve has also been identified as a preferred process to prepare the base oil to be used in the present invention. More preferred the first and second hydroisomerisation steps are performed in series flow. Most preferred the two steps are performed in a single reactor comprising beds of the above amorphous and/or crystalline catalyst.

In step (a) the feed is contacted with hydrogen in the presence of the catalyst at elevated temperature and pressure. The temperatures typically will be in the range of from 175 to 380° C., preferably higher than 250° C. and more preferably from 300 to 370° C. The pressure will typically be in the range of from 10 to 250 bar and preferably between 20 and 80 bar. Hydrogen may be supplied at a gas hourly space velocity of from 100 to 10000 Nl/l/hr, preferably from 500 to 5000 Nl/l/hr. The hydrocarbon feed may be provided at a weight hourly space velocity of from 0.1 to 5 kg/l/hr, preferably higher than 0.5 kg/l/hr and more preferably lower than 2 kg/l/hr. The ratio of hydrogen to hydrocarbon feed may range from 100 to 5000 Nl/kg and is preferably from 250 to 2500 Nl/kg.

The conversion in step (a) is defined as the weight percentage of the feed boiling above 370° C. which reacts per pass to a fraction boiling below 370° C., is at least 20 wt %, preferably at least 25 wt %, but preferably not more than 80 wt %, more preferably not more than 65 wt %. The feed as used above in the definition is the total hydrocarbon feed fed to step (a), thus also any optional recycle of a high boiling fraction which may be obtained in step (b).

In step (b) the product of step (a) is preferably separated into one or more distillate fuels fractions and a base oil or base oil precursor fraction having the desired viscosity properties. If the pour point is not in the desired range the pour point of the base oil is further reduced by means of a dewaxing step (c), preferably by catalytic dewaxing. In such an embodiment it may be a further advantage to dewax a wider boiling fraction of the product of step (a). From the resulting dewaxed product the base oil and oils having a desired viscosity can then be advantageously isolated by means of distillation. Dewaxing is preferably performed by catalytic dewaxing as for example described in WO-A-02070629, which publication is hereby incorporated by reference. The final boiling point of the feed to the dewaxing step (c) may be the final boiling point of the product of step (a) or lower if desired.

Alternatively, however less preferred due to the high costs involved for its preparation, the base oil preferably has a paraffin content of greater than 80 wt % paraffins and a saturates content of greater than 98 wt % and comprises a series of iso-paraffins having n, n+2 and n+4 carbon atoms, however not comprising n+1, and n+3, wherein n is between 15 and 40. Preferably, such a base oil is a hydrogenated polyalpha-olefin (PAO) homopolymerpolymer, i.e. an alpha olefin (PAO) derived base oil, generally classified as API Group IV base oil. More preferably, the PAO base oil has the composition comprising the hydrogenated dimmer, trimer, tetramer, pentamer, and hexamer of an alpha-olefin, such as 1-decene, 1-dodecene, or blends thereof.

Poly-alpha-olefins (PAO) are hydrocarbon blends suitable as synthetic base oils produced by the oligomerization of alpha-olefins or 1-alkenes. PAO is manufactured by oligomerization of a linear alpha olefin followed by hydrogenation to remove unsaturated moieties and fractionation to obtain the desired product slate. 1-decene is the most commonly used alpha olefin in the manufacture of PAO, but 1-octene, 1-dodecene and 1-tetradecene can also be used. PAO's are commonly categorized by the numbers denoting the approximate viscosity in centistokes of the PAO at 100° C. It is known that PAO 2, PAO 2.5, PAO 4, PAO 5, PAO 6, PAO 7, PAO 8, PAO 9 and PAO 10 and combinations thereof can be used in engine oils. The higher the viscosity, the longer the average chain length of the polyalphaolefin. The isomer distribution of a polyalphaolefin used will depend on the application. A typical polyalphaolefin prepared from 1-decene contains predominantly the trimer (C₃₀-hydrocarbons) with much smaller amounts of dimer, tetramer, pentamer, and hexamer. While 1-decene is the most common starting material, other alphaolefins can be used, depending on the needs of the product oil. The PAO oil contains a large number of isomers (e.g., the trimer of 1-decene contains many C₃₀ isomers, the tetramer contains many C₄₀ isomers) which result from skeletal branching during the oligomerization (Shubkin 1993). The most common of these are PAO 4, PAO 6 and PAO 8. Lubricant formulations comprising such PAO base oils have been described in Kirk-Othmer Encyclopedia of Chemical Technology, 3rd ed., 14, 477-526; U.S. Pat. No. 4,218,330 and EP-A-1051466.

Independently whether it is a Fischer-Tropsch derived base oil or a PAO-derived base oil, the base oil component suitably has a kinematic viscosity at 100° C. of from 1 to 25 mm²/sec. Preferably, it has a kinematic viscosity at 100° C. of from 2 to 15 mm²/sec, more preferably of from 2.5 to 8.5 mm²/sec, yet more preferably from 2.75 to 5.5 mm²/sec.

Obviously, mixture of the Fischer-Tropsch and the PAO-derived base oils may be employed as well.

The pour point of the base oil is preferably below −30° C.

The flash point of the base oil as measured by ASTM D92 preferably is greater than 120° C., more preferably even greater than 140° C.

The lubricant used in the package according to the invention preferably has a viscosity index in the range of from 100 to 600, more preferably a viscosity index in the range of from 110 to 200, and even more preferably a viscosity index in the range of from 120 to 150.

The lubricant used in the package according to the invention may comprise as the base oil component exclusively the paraffinic base oil, or a combination of the paraffinic base oils and ester as described above, or alternatively in combination with another additional base oil. The additional base oil will suitably comprise less than 20 wt %, more preferably less than 10 wt %, again more preferably less than 5 wt % of the total fluid formulation. Examples of such base oils are mineral based paraffinic and naphthenic type base oils and synthetic base oils, for example poly alpha olefins, poly alkylene glycols and the like. The amounts are limited by the nitrogen oxide reduction that is to be attained. Preferably, the lubricant further comprises saturated cyclic hydrocarbons in an amount of from 5 to 10% by weight, based on the total lubricant since this improves the low temperature compatibility of the different components in the lubricant.

The lubricant according to the invention further preferably comprises a viscosity improver in an amount of from 0.01 to 30% by weight. Viscosity index improvers (also known as VI improvers, viscosity modifiers, or viscosity improvers) provide lubricants with high- and low-temperature operability. These additives impart acceptable viscosity at low temperatures and are preferably shear stable. The lubricant used in the package according to the invention further preferably comprises at least one other additional lubricant component in effective amounts, such as for instance polar and/or non-polar lubricant base oils, and performance additives such as for example, but not limited to, metallic and ashless oxidation inhibitors, ashless dispersants, metallic and ashless detergents, corrosion and rust inhibitors, metal deactivators, metallic and non-metallic, low-ash, phosphorus-containing and non-phosphorus, sulphur-containing and non-sulphur-containing anti-wear agents, metallic and non-metallic, phosphorus-containing and non-phosphorus, sulphur-containing and non-sulphurous extreme pressure additives, anti-seizure agents, pour point depressants, wax modifiers, viscosity modifiers, seal compatibility agents, friction modifiers, lubricity agents, anti-staining agents, chromophoric agents, anti foaming agents, demulsifiers, and other usually employed additive packages. For a review of many commonly used additives, reference is made to D. Klamann in Lubricants and Related Products, Verlag Chemie, Deerfield Beach, Fla.; ISBN 0-89573-177-0, and to “Lubricant Additives” by M. W. Ranney, published by Noyes Data Corporation of Parkridge, N.J. (1973).

The present invention further relates to an engine arrangement for generation of kinematic and thermic energy comprising a lubricated diesel engine and a fuel distribution and storage system, wherein the engine lubricant comprises a Fischer-Tropsch derived base oil or base stock having a paraffin content of greater than 80 wt % paraffins and a saturates content of greater than 98 wt % and comprising a continuous series of iso-paraffins having n, n+1, n+2, n+3 and n+4 carbon atoms and wherein n is between 15 and 40, or (ii) a base oil or base stock having a paraffin content of greater than 80 wt % paraffins and a saturates content of greater than 98 wt % and comprising a series of iso-paraffins having n, n+2 and n+4, however not n+1 and n+3, wherein n is between 15 and 40; and wherein the fuel distribution and storage system contains a Fischer-Tropsch derived fuel.

This arrangement has the advantage that both fuel and lubricant are more biodegradable than the equivalent mineral oil based lubricant and/or fuels. Furthermore, the high oxidative stability of such fuels and lubricant will allow long periods of non-operation without affecting the quality of the fuel and lubricant, and hence reduced formation of oxidation products such as organic acids which lead to corrosion on the fuel distribution and storage system, and the engine. The engine may be of the direct injection type, for example of the rotary pump, in-line pump, unit pump, electronic unit injector or common rail type, or of the indirect injection type. It may be a heavy or a light duty diesel engine.

When running, the engine arrangement will produce less nitrogen oxides as compared to running on either mineral oil base diesel fuel using a Fischer-Tropsch or PAO derived lubricant, or a mineral oil-based lubricant and a Fischer-Tropsch derived Diesel fuel. The engine arrangement preferably forms part of a transportation vehicle, or a stationary device. More preferably, the transportation device is a heavy duty transportation device such as truck, or locomotive, or a lighter transportation device, such as a passenger car. Alternatively, it may form part of a stationary device such as a water pump, where it has the additional advantage that lubricant and fuel can be formulated in such way that they are not or hardly noxious to marine life forms in the case of pollution, as a result of the intrinsic high biodegradability of Fischer-Tropsch derived gas oils and base oils. Again, alternatively, it may form part of a stationary device such as a power device, for instance an emergency or auxiliary power generator, where the presence of highly oxidative stable base oil and fuel will allow prolonged periods of non-operation as compared to mineral oil based equivalents.

The present invention further relates to a process for power generation at reduced exhaust gas emission, comprising running a diesel engine on a fuel comprising a Fischer-Tropsch derived gas oil, wherein the engine is lubricated with a lubricant composition comprising a base oil or base stock having a paraffin content of greater than 80 wt % paraffins and a saturates content of greater than 98 wt %, and (i) comprising a continuous series of iso-paraffins having n, n+1, n+2, n+3 and n+4 carbon atoms and wherein n is between 15 and 40, and/or (ii) a series of iso-paraffins having n, n+2 and n+4 carbon atoms, however not n+1 and n+3, wherein n is between 15 and 40.

The invention will be further illustrated by the following, non-limiting examples:

### Example 1

### Fuel Compositions

Two automotive gas oil compositions were prepared: A Fischer-Tropsch automotive gas oil (F-T AGO) blend consisted of a base fuel (S040990) with 250 mg/kg R655 lubricity improver and STADIS 450 anti-static additive. The conventional automotive gas oil (mineral AGO) was a 50 ppm sulphur fuel meeting European EN590 specification. The fuel code was DK1703. The composition of the two fuels is depicted in Table 1:

TABLE 1

| | | | Comparative |
|---|---|---|---|
| Fuel property | Test method | F1 | F2 |
| Density @ 15° | IP 365/ | 0.7846 | 0.8326 |
| C. (g/cm³) | ASTM D4052 | | |
| Distillation | IP 123/ | | |
| | ASTM D86 | | |
| IBP (° C.) | | 219.5 | 169.0 |
| 10% | | 245.9 | 209.0 |
| 20% | | 258.8 | 231.0 |
| 30% | | 270.1 | 249.0 |
| 40% | | 282.5 | 262.5 |
| 50% | | 295.2 | 274.5 |
| 60% | | 307.2 | 285.5 |
| 70% | | 317.7 | 296.5 |
| 80% | | 328.1 | 309.0 |
| 90% | | 342.1 | 327.0 |
| 95% | | 353 | 342.0 |
| FBP | | 358.2 | 357.0 |
| Cetane number | ASTM D613 | 79 | 54.8 |
| Kinematic | IP 71/ | 3.497 | 2.895 |
| viscosity @ | ASTM D445 | | |
| 40° C. | | | |
| (centistokes) | | | |
| (mm²/s) | | | |
| Cloud point | DIN EN 23015 | −0.5 | −11 |
| (° C.) | | | |
| Sulphur | ASTM D2622 | <5 | 49 |
| (WDXRF) | | | |
| (ppmw) | | | |

The gas oil fuel F1 had been obtained from a Fischer-Tropsch (SMDS) synthesis product via a two-stage hydroconversion process analogous to that described in EP-A-0583836. The comparative fuel was a conventional, mineral-oil derived low-sulfur automotive gas oil.

### Lubricants

Two lubricant formulations were prepared. For purposes of this test, the base oils employed in the lubricant compositions were API Gp III base oils:

A first base oil (BO1) is a fully (100%) Fischer-Tropsch derived base oil using a Fischer-Tropsch waxy raffinate obtained from Shell SMDS Bintulu (Bintulu, Malaysia) as feed. This feed has been subject to a solvent de-waxing step, and had a kinematic viscosity at 100° C. of 5.0 cSt. For comparison, a blend (BO2) of two mineral-derived base oils derived from a hydrowax feedstock (also known as fuel hydrocracker bottoms), of the YuBase Gp III slate was employed, specifically YuBase 4 (BO2 component 1) and YuBase 6 (BO2 component 2, both commercially available from SK Base Oils, Ulsan, Korea). The blend had a kinematic viscosity at 100° C. of 5.0 cSt.

Both BO1 and BO2 were formulated into a lubricant with a commercially available additive package. The formulations are based on current commercial 5W-40 API—CH₄ medium ash heavy duty diesel engine oils, see Table 2.

The Fischer-Tropsch base oil blend was comparable with the YuBase blend in terms of Vk100C and cold crank viscosity (VdCCS) at −30° C. The Fischer-Tropsch base oil was slightly lower in Noack volatility even though its kinematic viscosity at 100° C. (VK100° C.) and its VdCCS was marginally lower than the YuBase analogue.

TABLE 2
5W-40 heavy duty diesel engine lubricant characteristics

| | | Comparative |
|---|---|---|
| Component | LB1 | LB |
| BO1 (F-T) | 74.41 | — |
| BO2 | — | 63 |
| component 1 | | |
| BO2 | — | 11 |
| component 2 | | |
| Additive | 13.0 | 13.0 |
| package 1 | | |
| Additive | 0.6 | 0.6 |
| package 2 | | |
| Pour point | 0.2 | 0.2 |
| depressant | | |
| Antioxidant | 0.5 | 0.5 |
| Viscosity | 11.29 | 11.7 |
| modifier | | |
| Kinematic | 14.46 | 14.27 |
| viscosity at | | |
| 100° C. [Cst] | | |
| CCS at −30° | 65.17 | 61.23 |
| C. [poise] | | |

The above lubricants and fuels compositions were employed to lubricate and to operate, respectively, an automotive heavy duty engine (Table 3):

TABLE 3
Engine specification and nominal performance data

| | |
|---|---|
| Model: | MAN TG-A410A |
| Engine: | MAN D2866 LF28 six-cylinder DI |
| | diesel with exhaust gas |
| | recirculation (EGR) |
| Cylinders: | six in-line |
| Bore/Stroke: | 128 × 155 mm |
| Capacity: | 11.97 litres |
| Maximum Power: | 403 hp (301 kW) at 1,900 rpm |
| Maximum Torque: | 1,850 Nm (1,363 lbft) between |
| | 900-1,300 rpm |
| Transmission: | ZF 16-speed direct drive with |
| | range-change, splitter and MAN |
| | Comfort Shift |

The Nitrogen oxide emissions were measured.

### Nitrogen Oxide Emissions Data for MAN Euro 3 Heavy Duty Engine

FIG. 1 shows a simple comparison of the measured NOx emissions after both pre-degreening of the lubricant oil for 15 hours and a further 85 hours of running the engine i.e. 100 hours total running time. (De-greening is a process of stabilisation of the lubricant where the additive anti-wear components are partially decomposed and laid down on metal surfaces and the most volatile light ends of base oil evaporate). The 13-mode European Stationary Cycle (ESC) was chosen as the basis for both mileage accumulation and emissions testing. In this test, the engine is tested on an engine dynamometer over a sequence of steady-state modes at equal power delivery. The engine is operated for a prescribed time in each mode, completing engine speed and load changes in the first 20 seconds. The specified speed is held to within ±50 rpm and the specified torque is held to within ±2% of the maximum torque at the test speed. Emissions are measured during each mode and averaged over the cycle using a set of weighting factors. Particulate matter emissions are sampled on one filter over the 13 modes. The final emission results are expressed in g/kW hr.

It can be seen in FIG. 1 a reduction in NOx emission is obtained when using a paraffinic (Fischer-Tropsch derived) gas oil as fuel compared to mineral low Sulphur diesel gas oil for a constant lubricant formulation. This holds respectively for both the paraffinic lubricant formulation according to the invention, as well as for the comparative mineral-derived Gp III base oil type formulation.

For the stabilised lubricant after a total of 100 hours engine running time it was unexpectedly noticed that the Fischer-Tropsch-base lubricant gave a significantly lower NOx emission than a mineral Gp III base oil based lubricant, when a simple and absolute comparison of the NOx emissions in units of grams/kilowatt hour (g/kW hr) of engine power output was made. After allowing for effects such as fuel consumption differences (as monitored through carbon dioxide emission), the combination of the paraffinic base oil according to the invention in the lubricant together with a paraffinic fuel according to the invention resulted in an unexpectedly synergistic, and non-linear large reduction of the nitrogen oxide emission per unit of carbon dioxide formed as compared to the paraffinic base oil in the lubricant combined with a mineral oil derived fuel, or the combination of a mineral-derived base oil in the lubricant with a paraffinic, Fischer-Tropsch derived automotive gas oil, as illustrated by Table 4.

TABLE 4
Values for the NOx reduction after allowing for related fuel consumption

| | | | | | | ratio of % NOx |
|---|---|---|---|---|---|---|
| | | | | | | benefit over % |
| | | delta NOx | | delta fuel | delta | difference in |
| | Measured | emissions | delta NOx | consumption | fuel | fuel |
| Experiment | effect | [g/kW hr] | benefit [%] | [g/kw hr] | cons. [%] | consumption |
| A. Mineral | Change | 0.60 | 9 | 30.1 | 4.3 | 2.01 |
| Gp III | from | | | | | |
| base oil | mineral | | | | | |
| (constant) | gas oil to | | | | | |
| | Fischer- | | | | | |
| | Tropsch | | | | | |
| | gas oil | | | | | |
| B. | Change | 0.53 | 11 | 27.0 | 3.9 | 2.86 |
| Fischer- | from | | | | | |
| Tropsch Gp | mineral | | | | | |
| III base | gas oil to | | | | | |
| oil | Fischer- | | | | | |
| (constant) | Tropsch | | | | | |
| | gas oil | | | | | |
| C. Mineral | Change | 0.26 | 5.2 | 7.73 | 1.1 | 4.66 |
| gas oil | from | | | | | |
| (constant) | mineral Gp | | | | | |
| | III base | | | | | |
| | oil to | | | | | |
| | Fischer- | | | | | |
| | Tropsch Gp | | | | | |
| | III base | | | | | |
| | oil | | | | | |
| D. | Change | 0.19 | 4.3 | 4.70 | 0.7 | 6.14 |
| Fischer- | from | | | | | |
| Tropsch | mineral Gp | | | | | |
| gas oil | III base | | | | | |
| (constant) | oil to | | | | | |
| | Fischer- | | | | | |
| | Tropsch Gp | | | | | |
| | III base | | | | | |
| | oil | | | | | |

Table 4 illustrates that there are two effects visible: A first effect is expressed by the change from a mineral gas oil to a Fischer-Tropsch derived gas oil at a constant base oil lubricant is in the same range; a second effect becomes visible when at a constant gas oil, the lubricant compositions are exchanged. Experiments A and B illustrate the beneficial effect of the Fischer-Tropsch derived gas oil on the NOx emission.

Experiments C and D illustrate that a combination of a Fischer-Tropsch derived gas oil and a Fischer-Tropsch derived base oil shows a higher reduction of Nitrogen oxides than the individual effects of either changing the base oil, or changing the fuel separately. Furthermore, it was found that upon prolonged application, the NOx emission benefit with the use of the combination according to the invention was maintained at the same level, while the emissions for the mineral oil derived lubricant formulation increased over time.

1. A combined lubricant and fuel composition package for operating a diesel engine, wherein the lubricant comprises a base oil comprising (i) a continuous series of iso-paraffins having n, n+1, n+2, n+3 and n+4 carbon atoms, and/or (ii) a continuous series of iso-paraffins having n, n+2 and n+4 carbon atoms and not containing n+1, and n+3; wherein n is between 15 and 40; and wherein the fuel composition comprises a paraffinic gas oil component having a paraffin content of greater than 80 wt % paraffins and a saturates content of greater than 98 wt %.

2. A combined lubricant and fuel package according to claim 1, wherein the paraffinic gas oil component comprises a series of iso-paraffins having n, n+1, n+2, n+3 and n+4 carbon atoms and wherein n is between 8 and 25.

3. A combined lubricant and fuel package according to claim 1, wherein the gas oil is a Fischer-Tropsch derived gas oil.

4. A combined lubricant and fuel package according to claim 1, wherein the base oil has a kinematic viscosity at 100° C. of from 3 to 25 mm²/s.

5. A combined lubricant and fuel package according to claim 1, wherein the fuel composition has an iso-paraffin to n-paraffin mass ratio that generally increases as paraffin carbon number increases from C8 to C18, and wherein the fuel comprises less than 0.05% m/m sulphur and less than 10% by mass aromatics.

6. A combined lubricant and fuel package according to claim 1, wherein the fuel has an average of more than 1 alkyl branch per paraffinic molecule.

7. A combined lubricant and fuel package according to claim 1, wherein the fuel comprises at least 50% wt. of iso-paraffins.

8. A combined lubricant and fuel package according to claim 1, wherein the fuel has a cetane number of at least 65.

9. An engine arrangement for generation of kinematic and thermic energy comprising (a) a diesel engine comprising a lubricating oil composition, and (b) a fuel distribution and storage system connected to the diesel engine, wherein the engine lubricant comprises a base oil or base stock having a paraffin content of greater than 80 wt % paraffins and a saturates content of greater than 98 wt % and comprises a series of iso-paraffins having n, n+1, n+2, n+3 and n+4 carbon atoms and wherein n is between 15 and 40, and wherein the base oil or base stock has a kinematic viscosity at 100° C. of from 3 to 8 mm²/s; and wherein the fuel distribution and storage system contains a fuel composition comprising a paraffinic gas oil component.

10. (canceled)

11. A process for power generation with reduced exhaust nitrogen oxide gas emission, comprising operating a diesel engine with a fuel composition comprising a paraffinic gas oil component having a paraffin content of greater than 80 wt % paraffins and a saturates content of greater than 98 wt %, and lubricating the engine with a lubricating oil composition; wherein the lubricant composition comprises a base oil or base stock having a paraffin content of greater than 80 wt % paraffins and a saturates content of greater than 98 wt % and comprises (i) a series of iso-paraffins having n, n+1, n+2, n+3 and n+4 carbon atoms and wherein n is between 15 and 40, and/or (ii) a series of iso-paraffins having n, n+2 and n+4 carbon atoms and not containing n+1, and n+3, and wherein n is between 15 and 40.

12. (canceled)
